(19) United States
(12) Patent Application Publication
(10) Pub. No.: US 2026/0051830 A1
(43) Pub. Date: Feb. 19, 2026

(54) MOTOR BRAKING SYSTEM USING MULTI-PHASE REVERSAL MECHANISM

(71) Applicant: ANPEC ELECTRONICS CORPORATION, HSINCHU (TW)

(72) Inventor: MING-JUNG TSAI, CHANGHUA COUNTY (TW)

(21) Appl. No.: 18/944,158

(22) Filed: Nov. 12, 2024

(30) Foreign Application Priority Data
Aug. 13, 2024 (TW) 113130234

(51) Int. Cl. H02P 3/20

(52) U.S. Cl. CPC H02P 3/20

(57) ABSTRACT

A motor braking system using a multi-phase reversal mechanism is provided. In a motor driving mode, the motor braking system, according to one or more of voltage signals respectively of three phases of a three-phase motor, determines which one of the three phases of the three-phase motor is a phase from which a current flows as a first driving phase, and selects another of the three phases of the three-phase motor as a second driving phase. In a motor braking mode, the motor braking system changes a driving operation performed on the three-phase motor such that a reverse current flows from the second driving phase to the first driving phase.

### CROSS-REFERENCE TO RELATED PATENT APPLICATION

This application claims the benefit of priority to Taiwan Patent Application No. 113130234, filed on Aug. 13, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor braking system using a multi-phase reversal mechanism.

### BACKGROUND OF THE DISCLOSURE

In an electronic device such as a server, a plurality of fans are often arranged and installed for cooling down a processor and other heat-generating components. When the plurality of fans rotate, hot air is expelled out of the electronic device along a forward direction, thereby reducing a temperature inside the electronic device. However, when any one of the plurality of fans is removed from the electronic device due to damage or other factors, gas in the air flows to a space where the removed fan was accommodated along a reverse direction. As a result, when a new fan is installed into the electronic device, the new fan inside the electronic device rotates in the reverse direction at a high rotational speed. Therefore, a braking method must be developed for preventing the new fan from rotating in the reverse direction. However, conventional motor drivers are currently unable to effectively and accurately brake a motor of the new fan.

### SUMMARY OF THE DISCLOSURE

In response to the above-referenced technical inadequacies, the present disclosure provides a motor braking system using a multi-phase reversal mechanism. The motor braking system is applicable to a three-phase motor. The motor braking system includes a motor voltage detecting circuit, a driver circuit, and an output stage circuit. The motor voltage detecting circuit is connected to the three-phase motor. The driver circuit is connected to the motor voltage detecting circuit. The driver circuit is configured to output a driving signal. The output stage circuit is connected to the driver circuit and the three-phase motor. The output stage circuit is configured to drive the three-phase motor according to the driving signal. In a motor driving mode, the motor voltage detecting circuit detects voltage signals of one or more of three phases of the three-phase motor to output a voltage detected signal. In the motor driving mode, the driver circuit, according to the voltage detected signal, determines which one of the three phases of the three-phase motor is a phase from which a current flows as a first driving phase, and selects another of the three phases of the three-phase motor as a second driving phase. In a motor braking mode, the driver circuit changes the driving signal such that a reverse current flows from the second driving phase to the first driving phase.

In addition, the present disclosure provides a motor braking system using a multi-phase reversal mechanism. The motor braking system is applicable to a three-phase motor. The motor braking system includes a rotor position detecting circuit, a driver circuit and an output stage circuit. The rotor position detecting circuit is disposed on the three-phase motor. The driver circuit is connected to the rotor position detecting circuit. The driver circuit is configured to output a driving signal. The output stage circuit is connected to the driver circuit and the three-phase motor. The output stage circuit is configured to drive the three-phase motor according to the driving signal. In a motor driving mode, the rotor position detecting circuit detects a position of a rotor of the three-phase motor to output a commutation signal. The driver circuit drives the output stage circuit according to the commutation signal. In the motor driving mode, the driver circuit, according to the commutation signal, determines which one of three phases of the three-phase motor is a phase from which a current flows as a first driving phase, and selects another of the three phases of the three-phase motor as a second driving phase. In a motor braking mode, the driver circuit changes the driving signal such that a reverse current flows from the second driving phase to the first driving phase.

As described above, the present disclosure provides the motor braking system using the multi-phase reversal mechanism. The motor braking system of the present disclosure precisely controls rotation of the three-phase motor of a device (such as a fan). In particular, the motor braking system of the present disclosure is capable of effectively reducing the rotational speed of the three-phase motor for braking the three-phase motor. When any one of the plurality of fans is removed from the accommodation space in the electronic device (such as a server) and a new fan is installed into the electronic device, the motor braking system of the present disclosure brakes the three-phase motor of the one of the plurality of fan, thereby preventing the fans in the electronic device from rotating abnormally along the reverse direction.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of fans driven by a motor braking system using a multi-phase reversal mechanism according to a first embodiment of the present disclosure;

FIG. 2 is a block diagram of the motor braking system using the multi-phase reversal mechanism according to the first embodiment of the present disclosure;

FIG. 3 is a circuit diagram of a three-phase motor driven by a motor braking system using a multi-phase reversal mechanism according to a second embodiment of the present disclosure;

FIG. 4 is a block diagram of a motor braking system using a multi-phase reversal mechanism according to a third embodiment of the present disclosure;

FIG. 5 is a waveform diagram of signals of the motor braking system using the multi-phase reversal mechanism according to the third embodiment of the present disclosure;

FIG. 6 is a circuit diagram of a three-phase motor having a W-phase terminal and a common node that are detected by a comparator of a motor braking system using a multi-phase reversal mechanism according to a fourth embodiment of the present disclosure;

FIG. 7 is a circuit diagram of a three-phase motor having a W-phase terminal and a ground terminal or a common voltage that are detected by a comparator of a motor braking system using a multi-phase reversal mechanism according to a fifth embodiment of the present disclosure;

FIG. 8 is a waveform diagram of signals of a motor braking system using a multi-phase reversal mechanism according to a sixth embodiment of the present disclosure;

FIG. 9 is a block diagram of a motor braking system using a multi-phase reversal mechanism according to a seventh embodiment of the present disclosure;

FIG. 10 is a block diagram of a motor braking system using a multi-phase reversal mechanism according to an eighth embodiment of the present disclosure;

FIG. 11 is a waveform diagram of signals of the motor braking system using the multi-phase reversal mechanism according to the eighth embodiment of the present disclosure;

FIG. 12 is a curve diagram of signals of the motor braking system using the multi-phase reversal mechanism according to the eighth embodiment of the present disclosure; and

FIG. 13 is a waveform diagram of signals of the motor braking system using the multi-phase reversal mechanism according to the eighth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

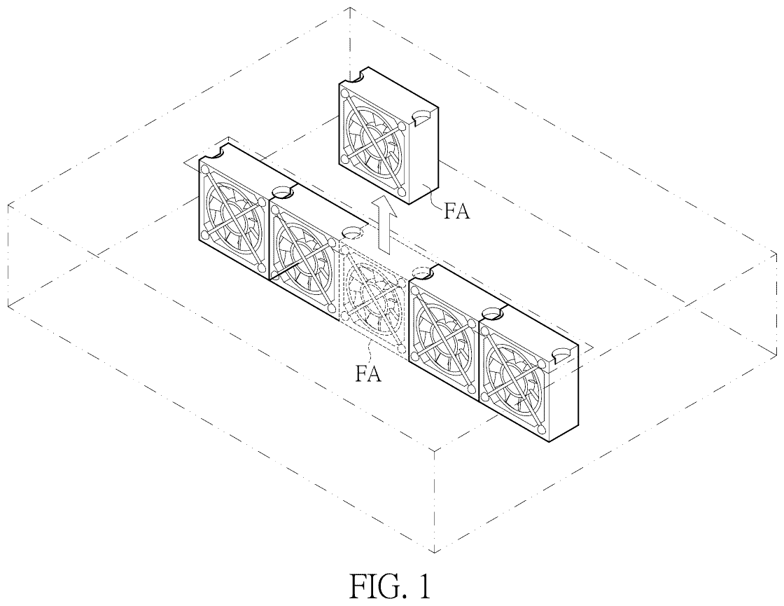

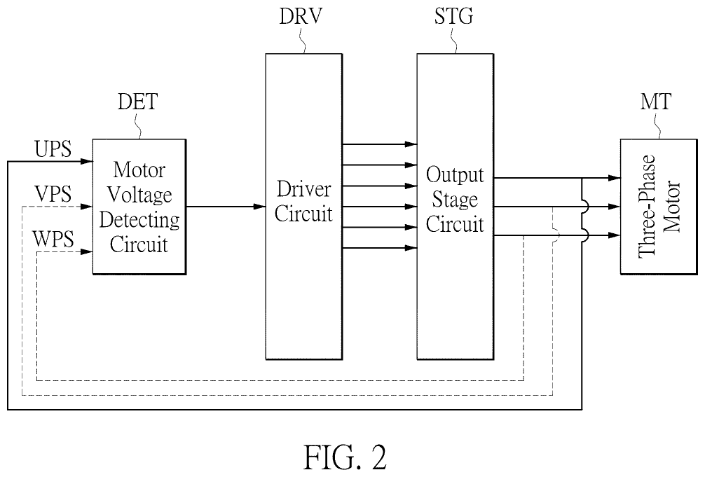

Reference is made to FIG. 1 and FIG. 2, in which FIG. 1 is a schematic diagram of fans driven by a motor braking system using a multi-phase reversal mechanism according to a first embodiment of the present disclosure, and FIG. 2 is a block diagram of the motor braking system using the multi-phase reversal mechanism according to the first embodiment of the present disclosure.

The motor braking system of the present disclosure is capable of reducing rotational speeds of a plurality of devices for braking the plurality of devices such as fans FA shown in FIG. 1.

When any one of the plurality of fans FA installed in a row is removed from an accommodation space inside an electronic device (such as a server) due to damage or other factors and a new fan is installed into the electronic device, the fans FA and the new fan are prevented from abnormally rotating along a reverse direction by the motor braking system of the present disclosure.

The motor braking system of the present disclosure includes a motor voltage detecting circuit DET, a driver circuit DRV and an output stage circuit STG as shown in FIG. 2.

The motor voltage detecting circuit DET is connected to a three-phase motor MT. The driver circuit DRV is connected to the motor voltage detecting circuit DET. The motor voltage detecting circuit DET is connected to the driver circuit DRV and the three-phase motor MT.

In a motor driving mode, the output stage circuit STG drives the three-phase motor MT according to a driving signal from the driver circuit DRV.

In the motor driving mode, the motor voltage detecting circuit DET detects one or more of a plurality of voltage signals UPS, VPS, WPS respectively of three phases that are a U-phase, V-phase and W-phase of the three-phase motor MT to output a voltage detected signal. For example, the motor voltage detecting circuit DET may include a selector circuit (such as a multiplexer), the motor voltage detecting circuit DET selects one of the plurality of voltage signals UPS, VPS, WPS respectively of the three phases of the three-phase motor MT and outputs the voltage detected signal according to the one of the plurality of voltage signals UPS, VPS, WPS.

In the motor driving mode, the driver circuit DRV, according to the voltage detected signal from the motor voltage detecting circuit DET, determines which one of the three phases of the three-phase motor MT is a phase from which a current flows and determines which one of the three phases of the three-phase motor MT is a phase to which the current flows. In the motor driving mode, the driver circuit DRV uses the phase from which the current flows as a first driving phase, and selects another of the three phases of the three-phase motor MT as a second driving phase.

It is worth noting that, in a motor braking mode, the driver circuit DRV changes the driving signal outputted to the output stage circuit STG such that a reverse current flows from the second driving phase to the first driving phase of the three-phase motor MT.

If the current flows from the U-phase to the V-phase of the three-phase motor MT in the motor driving mode, the reverse current flows from the V-phase to the U-phase of the three-phase motor MT in the motor braking mode. Conversely, if the current flows from the V-phase to the U-phase of the three-phase motor MT in the motor driving mode, the reverse current flows from the U-phase to the V-phase of the three-phase motor MT in the motor braking mode.

If the current flows from the V-phase to the W-phase of the three-phase motor MT in the motor driving mode, the reverse current flows from the W-phase to the V-phase of the three-phase motor MT in the motor braking mode. Conversely, if the current flows from the W-phase to the V-phase of the three-phase motor MT in the motor driving mode, the reverse current flows from the V-phase to the W-phase of the three-phase motor MT in the motor braking mode.

If the current flows from the W-phase to the U-phase of the three-phase motor MT in the motor driving mode, the reverse current flows from the U-phase of the three-phase motor MT to the W-phase of the three-phase motor MT in the motor braking mode. Conversely, if the current flows from the U-phase to the W-phase of the three-phase motor MT in the motor driving mode, the reverse current flows from the W-phase to the U-phase of the three-phase motor MT in the motor braking mode.

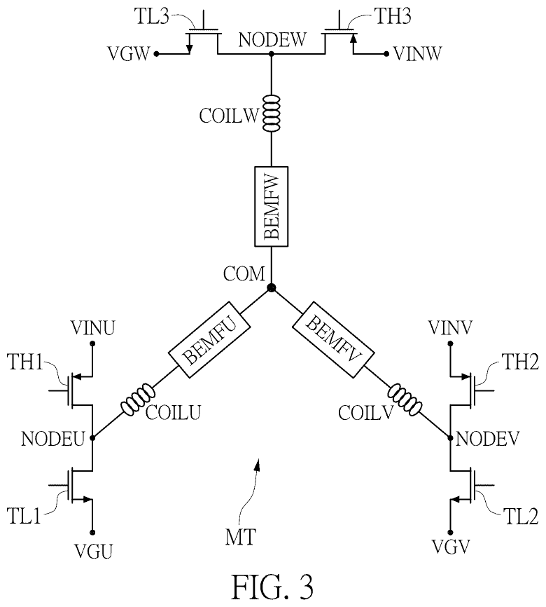

Reference is made to FIG. 3, which is a circuit diagram of a three-phase motor driven by a motor braking system using a multi-phase reversal mechanism according to a second embodiment of the present disclosure.

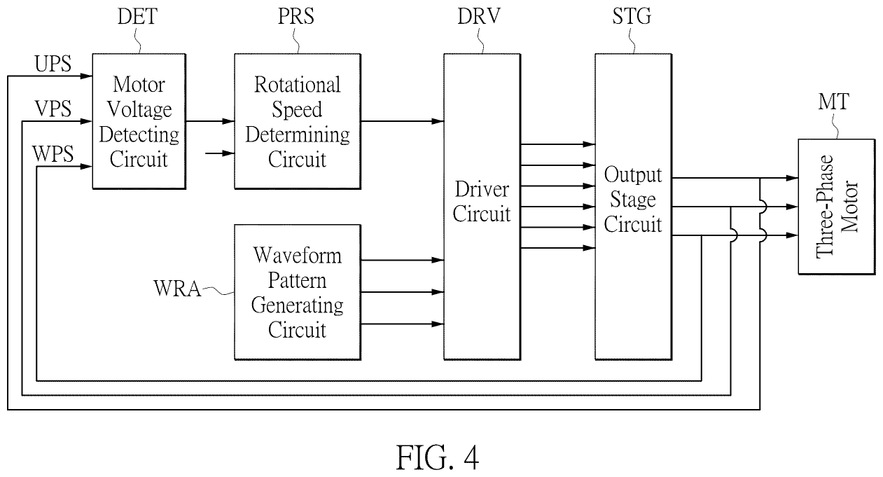

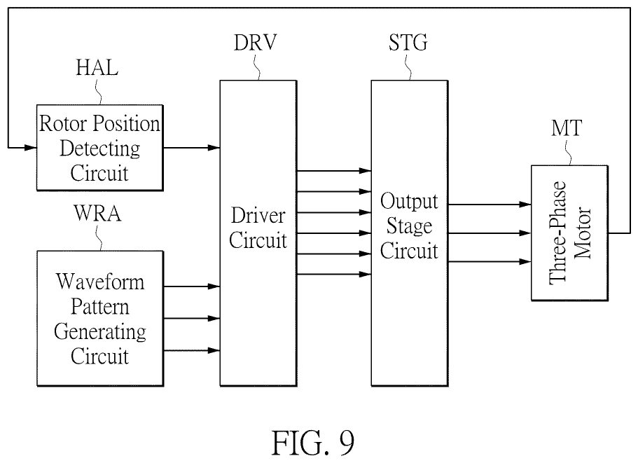

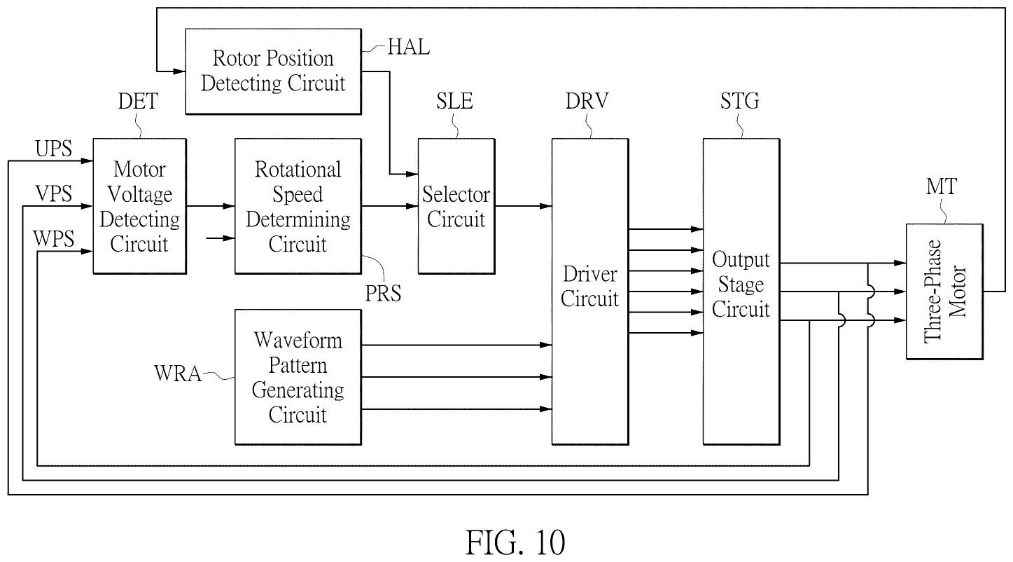

An output stage circuit of the motor braking system of the present disclosure such as the output stage circuit STG shown in FIG. 2, FIG. 4, FIG. 9 and FIG. 10 may include a plurality of high-side switches such as a first high-side switch TH1, a second high-side switch TH2 and a third high-side switch TH3 as shown in FIG. 3, and may include a plurality of low-side switches such as a first low-side switch TL1, a second low-side switch TL2 and a third low-side switch TL3 as shown in FIG. 3.

As shown in FIG. 3, a first terminal of the first high-side switch TH1 is coupled to a first input supply voltage VINU. A first terminal of the first low-side switch TL1 is connected to a second terminal of the first high-side switch TH1. A first node NODEU between the first terminal of the first low-side switch TL1 and the second terminal of the first high-side switch TH1 is connected to a first terminal of a first phase coil COILU of the three-phase motor MT. A second terminal of the first low-side switch TL1 is coupled to a first reference voltage level VGU.

A first terminal of the second high-side switch TH2 is coupled to a second input supply voltage VINV. A first terminal of the second low-side switch TL2 is connected to a second terminal of the second high-side switch TH2. A second node NODEV between the first terminal of the second low-side switch TL2 and the second terminal of the second high-side switch TH2 is connected to a first terminal of a second phase coil COILV of the three-phase motor MT. A second terminal of the second low-side switch TL2 is coupled to a second reference voltage level VGV.

A first terminal of the third high-side switch TH3 is coupled to a third input supply voltage VINW. A first terminal of the third low-side switch TL3 is connected to a second terminal of the third high-side switch TH3. A third node NODEW between the first terminal of the third low-side switch TL3 and the second terminal of the third high-side switch TH3 is coupled to a first terminal of a third phase coil COILW of the three-phase motor MT. A second terminal of the third low-side switch TL3 is coupled to a third reference voltage level VGW.

A second terminal of the first phase coil COILU, a second terminal of the second phase coil COILV and a second terminal of the third phase coil COILW are connected to a common node COM.

The driver circuit DRV outputs a plurality of driving signals respectively to a control terminal of the first high-side switch TH1, a control terminal of the second high-side switch TH2, a control terminal of the third high-side switch TH3, a control terminal of the first low-side switch TL1, a control terminal of the second low-side switch TL2, and a control terminal of the third low-side switch TL3.

In the motor driving mode, the driver circuit DRV determines which one of the three phases of the three-phase motor MT is the phase from which the current flows and determines which one of the three phases of the three-phase motor MT is the phase to which the current flows. In the motor driving mode, the driver circuit DRV uses the phase from which the current flows as the first driving phase, and selects another of the three phases of the three-phase motor MT as the second driving phase.

It is worth noting that, in the motor driving mode, the driver circuit DRV turns on one of the plurality of high-side switches that is connected to the first driving phase of the three-phase motor MT, and turns on one of the plurality of low-side switches that is connected to the second driving phase of the three-phase motor MT. In the motor braking mode, the driver circuit DRV turns on one of the plurality of high-side switches that is connected to the second driving phase of the three-phase motor MT, and turns on one of the plurality of low-side switches that is connected to the first driving phase of the three-phase motor MT.

For example, in the motor driving mode, the driver circuit DRV turns on the third high-side switch TH3 connected to the first terminal of the third phase coil COILW of the W-phase of the three-phase motor MT, and turns on the second low-side switch TL2 connected to the first terminal of the second phase coil COILV of the V-phase of the three-phase motor MT. Accordingly, in the motor braking mode, the driver circuit DRV turns on the second high-side switch TH2 that is connected to the first terminal of the second phase coil COILV of the V-phase of the three-phase motor MT, and turns on the third low-side switch TL3 that is connected to the first terminal of the third phase coil COILW of the W-phase of the three-phase motor MT.

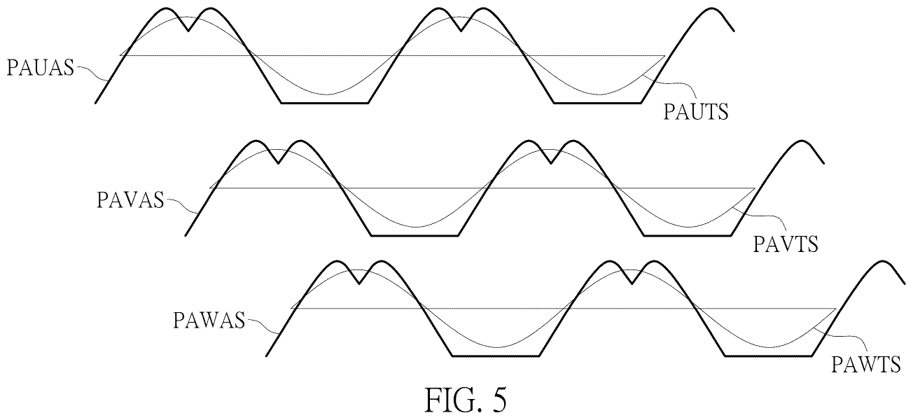

Reference is made to FIG. 4 and FIG. 5, in which FIG. 4 is a block diagram of a motor braking system using a multi-phase reversal mechanism according to a third embodiment of the present disclosure, and FIG. 5 is a waveform diagram of signals of the motor braking system using the multi-phase reversal mechanism according to the third embodiment of the present disclosure.

The descriptions of the third embodiment of the present disclosure that is the same as the descriptions of the first embodiment of the present disclosure are not repeated herein.

A difference between the third and first embodiments is that, the motor braking system of the third embodiment of the present disclosure may further include a waveform pattern generating circuit WRA and a rotational speed determining circuit PRS as shown in FIG. 4. The rotational speed determining circuit PRS is connected to the motor voltage detecting circuit DET. The waveform pattern generating circuit WRA and the rotational speed determining circuit PRS are connected to the driver circuit DRV.

In the motor driving mode and the motor braking mode, the motor voltage detecting circuit DET detects one or more of the plurality of voltage signals UPS, VPS, WPS respectively of the three phases of the three-phase motor MT to output the voltage detected signal. The rotational speed determining circuit PRS determines a rotational speed of the three-phase motor MT to output a motor rotational speed indicating signal according to the voltage detected signal.

In the motor driving mode and the motor braking mode, the driver circuit DRV may, according to a target rotational speed of the three-phase motor MT, obtain some of a plurality of reference pattern waveform signals such as a plurality of third harmonic waveforms PAUAS, PAVAS, PAWAS or a plurality of sine waveforms PAUTS, PAVTS, PAWTS as shown in FIG. 5 from the waveform pattern generating circuit WRA.

In the motor driving mode, the driver circuit DRV, according to the motor rotational speed indicating signal and the plurality of reference pattern waveform signals, drives the output stage circuit STG so as to drive the three-phase motor MT such that the motor rotational speed of three-phase motor MT is gradually increased to reach the target rotational speed or is maintained at the target rotational speed.

In the motor braking mode, the driver circuit DRV, according to the motor rotational speed indicating signal and the plurality of reference pattern waveform signals, drives the output stage circuit STG to reduce the rotational speed of the three-phase motor MT for braking three-phase motor MT.

It is worth noting that, in the motor driving mode, the driver circuit DRV determines which one of a plurality of waveform segments of the motor rotational speed indicating signal to be corresponded to one of a plurality of waveform segments each being at a high level or a low level in the plurality of voltage signals UPS, VPS, WPS indicated by the voltage detected signal. Accordingly, the driver circuit DRV determines which one of the three phases of the three-phase motor MT is the phase from which the current flows and determines which one of the three phases of the three-phase motor MT is the phase to which the current flows within a time interval of each of the plurality of waveform segments of the motor rotational speed indicating signal. In the motor driving mode, the driver circuit DRV uses the phase from which the current flows as the first driving phase, and selects another of the three phases of the three-phase motor MT as the second driving phase.

In the motor braking mode, the driver circuit DRV changes the driving signal and outputs the changed driving signal to the output stage circuit STG such that the reverse current flows from the second driving phase to the first driving phase of the three-phase motor MT.

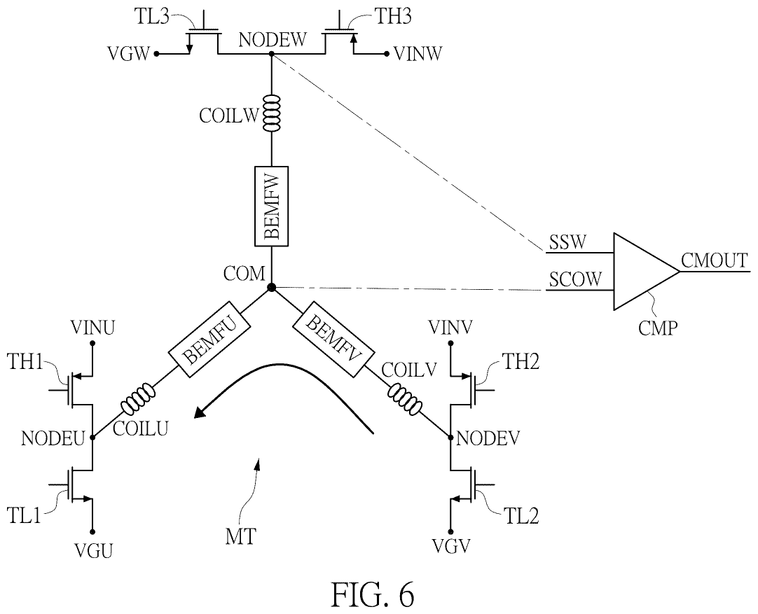

Reference is made to FIG. 6, which is a circuit diagram of a three-phase motor having a W-phase terminal and a common node that are detected by a comparator of a motor braking system using a multi-phase reversal mechanism according to a fourth embodiment of the present disclosure. The descriptions of the fourth embodiment of the present disclosure that are the same as the descriptions of the second embodiment of the present disclosure are not repeated herein.

The motor braking system of the present disclosure may include a comparator CMP. As shown in FIG. 6, the current flows from the V-phase to the U-phase of the three-phase motor MT (or from the U-phase to the V-phase of the three-phase motor MT in practice). At this time, a first input terminal such as a non-inverting input terminal of the comparator CMP is connected to the first terminal of the third phase coil COILW of the W-phase of the three-phase motor MT, or is connected to the third node NODEW between the first terminal of the third low-side switch TL3 and the second terminal of the third high-side switch TH3.

In practice, when the current flows from the V-phase to the W-phase of the three-phase motor MT or from the W-phase to the V-phase of the three-phase motor MT, the first input terminal of the comparator CMP or another comparator is connected to the first terminal of the first phase coil COILU, or is connected to the first node NODEU between the first terminal of the first low-side switch TL1 and the second terminal of the first high-side switch TH1.

In practice, when the current flows from the U-phase to the W-phase of the three-phase motor MT or from the W-phase to the U-phase of the three-phase motor MT, the first input terminal of the comparator CMP or another comparator is connected to the first terminal of the second phase coil COILV, or is connected to the second node NODEV between the first terminal of the second low-side switch TL2 and the second terminal of the second high-side switch TH2.

Alternatively, the rotational speed determining circuit PRS connected between the motor voltage detecting circuit DET and the driver circuit DRV as shown in FIG. 4 may be replaced with the comparator CMP shown in FIG. 6. The first input terminal of the comparator CMP may be connected to the motor voltage detecting circuit DET, and may receive the motor voltage detecting circuit DET from the motor voltage detecting circuit DET.

A second input terminal such as an inverting input terminal of the comparator CMP is connected to the common node COM of the three-phase motor MT.

The comparator CMP compares a voltage of a voltage signal SSW that is received from the third node NODEW by the first input terminal of the comparator CMP with a voltage of a common node voltage signal SCOM that is received from the common node COM by the second input terminal of the comparator CMP to output a comparing signal CMOUT. A voltage difference between the voltage of the voltage signal SSW of the third node NODEW and the voltage of the common node voltage signal SCOM of the common node COM that are compared with each other by the comparator CMP is equal to a back electromotive force voltage BEMFW.

When the back electromotive force voltage BEMFW is a positive voltage being higher than a zero voltage, the comparator CMP outputs the comparing signal CMOUT at a high level. When the back electromotive force voltage BEMFW is a negative voltage being lower than the zero voltage, the comparator CMP outputs the comparing signal CMOUT at a low level. A position of a rotor of the three-phase motor MT is determined according to a zero cross point that is a time point at which the back electromotive force voltage BEMFW reaches the zero voltage. The position of the rotor of the three-phase motor MT and a flowing direction of the current of the three-phase motor MT are determined according to the high and low levels of the comparing signal CMOUT.

The driver circuit DRV, according to the comparing signal CMOUT from the comparator CMP, determines which one of the three phases of the three-phase motor MT is the phase from which the current flows and determines which one of the three phases of the three-phase motor MT is the phase to which the current flows. Accordingly, the driver circuit DRV changes the driving signal and outputs the changed driving signal to the output stage circuit STG such that the reverse current flows through the three-phase motor MT.

For example, as shown in FIG. 6, when the current flows from the V-phase to the U-phase of the three-phase motor MT, no current flows through the W-phase of the third phase coil COILW of the three-phase motor MT. For example, when the third high-side switch TH3 and the third low-side switch TL3 are turned off, no current flows through the W-phase of the third phase coil COILW of the three-phase motor MT. At this time, an open circuit is between the common node COM and the third node NODEW, and the back electromotive force voltage BEMFW is at the third node NODEW. Therefore, when the common node COM and the third node NODEW are observed, the back electromotive force voltage BEMFW is observed. When the back electromotive force voltage BEMFW is changed to be higher or lower than the voltage of the common node COM, the comparing signal CMOUT outputted by the comparator CMP is changed.

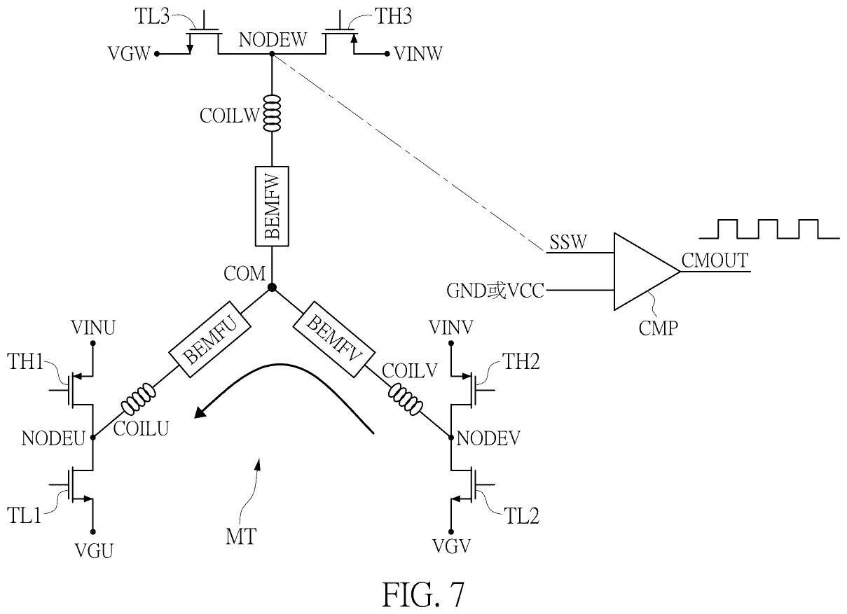

Reference is made to FIG. 7, which is a circuit diagram of a three-phase motor having a W-phase terminal and a ground terminal or a common voltage that are detected by a comparator of a motor braking system using a multi-phase reversal mechanism according to a fifth embodiment of the present disclosure.

The descriptions of the fifth embodiment of the present disclosure that are the same as the descriptions of the fourth embodiment of the present disclosure are not repeated herein.

A difference between the fifth and fourth embodiments of the present disclosure is that, as shown in FIG. 7, in the fifth embodiment, the second input terminal such as the inverting input terminal of the comparator CMP is coupled to a ground GND or a common voltage VCC rather than being connected to the common node COM of the three-phase motor MT.

When the current flows to the W-phase of the three-phase motor MT (through the third node NODEW from the common node COM) and both of the third high-side switch TH3 and the third low-side switch TL3 are turned off, the current flows to the third input supply voltage VINW through the third high-side switch TH3. At this time, a voltage of the third node NODEW is higher than the common voltage VCC.

Conversely, when the current flows from the W-phase of the three-phase motor MT (through the third node NODEW to the common node COM) and both of the third high-side switch TH3 and the third low-side switch TL3 are turned off, the current flows from the ground GND through the third low-side switch TL3 to the third node NODEW. At this time, the voltage of the third node NODEW is lower than a voltage of the ground GND.

Therefore, in the fifth embodiment, the flowing direction of the current is determined according to whether the voltage of the third node NODEW is higher than the common voltage VCC or is lower than the voltage of the ground GND for learning the position of the rotor of the three-phase motor MT. This manner of the fifth embodiment is different from that of the fourth embodiment. In the fifth embodiment, the current flowing through the W-phase does not need to be reduced to a zero value.

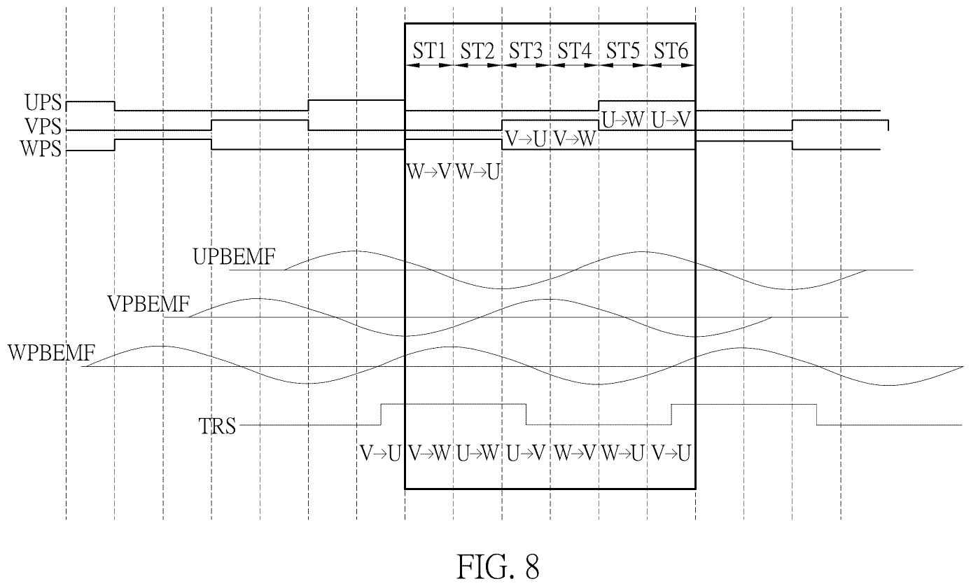

Reference is made to FIG. 8, which is a waveform diagram of signals of a motor braking system using a multi-phase reversal mechanism according to a sixth embodiment of the present disclosure.

A driver circuit of the motor braking system of the present disclosure such as the driver circuit DRV shown in FIG. 4 divides each of a plurality of operation cycle periods of the three-phase motor MT into a plurality of time intervals such as first time interval ST1, a second time interval ST2, a third time interval ST3, a fourth time interval ST4, a fifth time interval ST5 and a sixth time interval ST6 as shown in FIG. 8.

The motor voltage detecting circuit DET shown in FIG. 4 detects a voltage signal UPS shown in FIG. 8. The voltage signal UPS is a voltage signal of a U-phase terminal of the three-phase motor MT, or is a voltage signal of the first node NODEU between the first terminal of the first low-side switch TL1 and the second terminal of the first high-side switch TH1.

In addition or alternatively, the motor voltage detecting circuit DET shown in FIG. 4 detects a voltage signal VPS shown in FIG. 8. The voltage signal VPS is a voltage signal of a V-phase terminal of the three-phase motor MT, or is a voltage signal of the second node NODEV between the first terminal of the second low-side switch TL2 and the second terminal of the second high-side switch TH2.

In addition or alternatively, the motor voltage detecting circuit DET shown in FIG. 4 detects a voltage signal WPS shown in FIG. 8. The voltage signal WPS is a voltage signal of the W-phase terminal of the three-phase motor MT, or is a voltage signal of the third node NODEW between the first terminal of the third low-side switch TL3 and the second terminal of the third high-side switch TH3.

The voltage detected signal outputted by the motor voltage detecting circuit DET shown in FIG. 4 or the comparing signal CMOUT outputted by the comparator CMP shown in FIG. 6 or FIG. 7 may be the same as a voltage detected signal TRS shown in FIG. 8.

The driver circuit DRV may determine each of a plurality of waveform segments of the motor rotational speed indicating signal to be corresponded to which one of a plurality of waveform segments each being at the high level or the low level in the plurality of voltage signals UPS, VPS, WPS indicated by the voltage detected signal TRS. Accordingly, the driver circuit DRV determines which one of the first to sixth time intervals ST1 to ST6 is a time interval within which the current time falls, and further determines which one of the three phases of the three-phase motor MT is the phase from which the current flows and which one of the three phases of the three-phase motor MT is the phase to which the current flows in the motor driving mode.

When the three-phase motor MT enters the motor braking mode from the motor driving mode, the driver circuit DRV changes the driving signal and outputs the changed driving signal such that the reverse current flows through the three-phase motor MT to reduce the rotational speed of the three-phase motor MT for braking the three-phase motor MT. A back electromotive force current UPBEMF flowing through the U-phase of the three-phase motor MT, a back electromotive force current VPBEMF flowing through the V-phase of the three-phase motor MT and a back electromotive force current WPBEMF flowing through the W-phase of the three-phase motor MT are shown in FIG. 8.

In the sixth embodiment, the driver circuit DRV divides the plurality of operation cycle periods of the three-phase motor MT into the plurality of time intervals such as the first to sixth time intervals ST1 to ST6 shown in FIG. 8. The three-phase motor MT is braked within each of the first to sixth time intervals ST1 to ST6, which is described specifically as follows.

Within the first time interval ST1, the current flows from a third one (such as the W-phase) of the three phases of the three-phase motor MT to a second one (such as the V-phase) of the three phases of the three-phase motor MT. Within the first time intervals ST1, the driver circuit DRV changes the driving signal and outputs the changed driving signal to the output stage circuit STG such that the reverse current flows from the second one (such as the V-phase) of the three phases of the three-phase motor MT to the third one (such as the W-phase) of the three phases of the three-phase motor MT.

Within the second time interval ST2, the current flows from the third one (such as the W-phase) of the three phases of the three-phase motor MT to a first one (such as the U-phase) of the three phases of the three-phase motor MT. Within the second time interval ST2, the driver circuit DRV changes the driving signal and outputs the changed driving signal to the output stage circuit STG such that the reverse current flows from the first one (such as the U-phase) of the three phases of the three-phase motor MT to the third one (such as the W-phase) of the three phases of the three-phase motor MT.

Within the third time interval ST3, the current flows from the second one (such as the V-phase) of the three phases of the three-phase motor MT to the first one (such as the U-phase) of the three phases of the three-phase motor MT. Within the third time interval ST3, the driver circuit DRV changes the driving signal and outputs the changed driving signal to the output stage circuit STG such that the reverse current flows from the first one (such as the U-phase) of the three phases of the three-phase motor MT to the second one (such as the V-phase) of the three phases of the three-phase motor MT.

Within the fourth time interval ST4, the current flows from the second one (such as the V-phase) of the three phases of the three-phase motor MT as the first driving phase to the third one (such as the W-phase that) of the three phases of the three-phase motor MT as the second driving phase. Within the fourth time interval ST4, the driver circuit DRV changes the driving signal and outputs the changed driving signal to the output stage circuit STG such that the reverse current flows from the third one (such as the W-phase) of the three phases of the three-phase motor MT as the second driving phase to the second one (such as the V-phase) of the three phases of the three-phase motor MT as the first driving phase.

Within the fifth time interval ST5, the current flows from the first one (such as the U-phase) of the three phases of the three-phase motor MT as the first driving phase to the third one (such as the W-phase) of the three phases of the three-phase motor MT as the second driving phase. Within the fifth time interval ST5, the driver circuit DRV changes the driving signal and outputs the changed driving signal to the output stage circuit STG such that the reverse current flows from the third one (such as the W-phase) of the three phases of the three-phase motor MT as the second driving phase to the first one (such as the U-phase) of the three phases of the three-phase motor MT as the first driving phase.

Within the sixth time intervals ST6, the current flows from the first one (such as the U-phase) of the three phases of the three-phase motor MT as the first driving phase to the second one (such as the V-phase) of the three phases of the three-phase motor MT as the second driving phase. Within the sixth time interval ST6, the driver circuit DRV changes the driving signal and outputs the changed driving signal to the output stage circuit STG such that the reverse current flows from the second one (such as the V-phase) of the three phases of the three-phase motor MT as the second driving phase to the first one (such as the U-phase) of the three phases of the three-phase motor MT as the first driving phase.

An order of the first to sixth time intervals ST1 to ST6 included in each of the plurality of operation cycle periods of the three-phase motor MT is exemplified in FIG. 8, but may be adjusted according to actual requirements in practice, and the present disclosure is not limited thereto.

Reference is made to FIG. 9, which is a block diagram of a motor braking system using a multi-phase reversal mechanism according to a seventh embodiment of the present disclosure.

As shown in FIG. 9, in the seventh embodiment, the motor braking system of the present disclosure includes a rotor position detecting circuit HAL, the driver circuit DRV and the output stage circuit STG. If necessary, the motor braking system of the present disclosure may further include a waveform pattern generating circuit WRA. The waveform pattern generating circuit WRA is described above and thus is not repeated in the following.

The rotor position detecting circuit HAL is disposed on the three-phase motor MT and connected to the driver circuit DRV. The rotor position detecting circuit HAL is configured to detect the position of the rotor of the three-phase motor MT.

For example, the rotor position detecting circuit HAL may include a Hall sensor. The rotor position detecting circuit HAL senses a positive voltage and a negative voltage that are generated with a change in a magnetic field generated by the three-phase motor MT whose rotor is rotating to output the commutation signal.

In the motor driving mode, the driver circuit DRV determines which one of the three phases of the three-phase motor MT is the phase from which the current flows and determines which one of the three phases of the three-phase motor MT is the phase to which the current flows. In the motor driving mode, the driver circuit DRV uses the phase from which the current flows as the first driving phase, and selects another of the three phases of the three-phase motor MT as the second driving phase.

It is worth noting that, in the motor braking mode, the driver circuit DRV changes the driving signal and outputs the changed driving signal to the output stage circuit STG such that a braking current is generated.

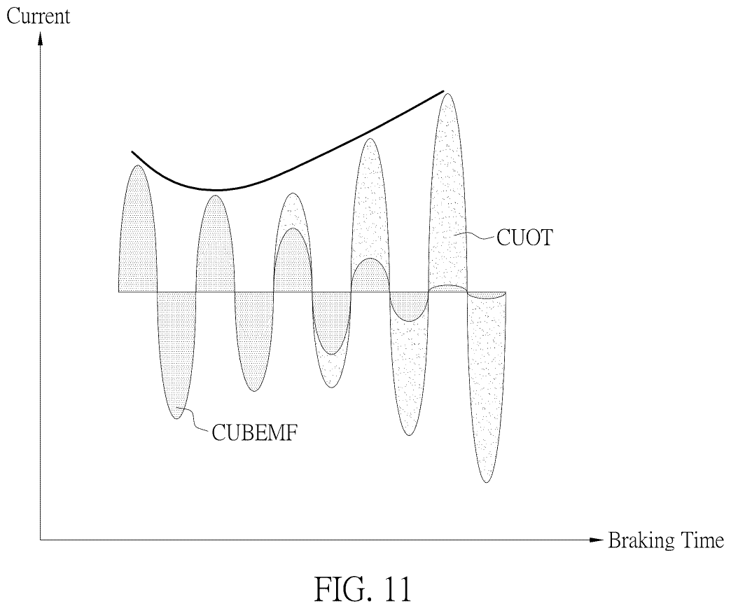

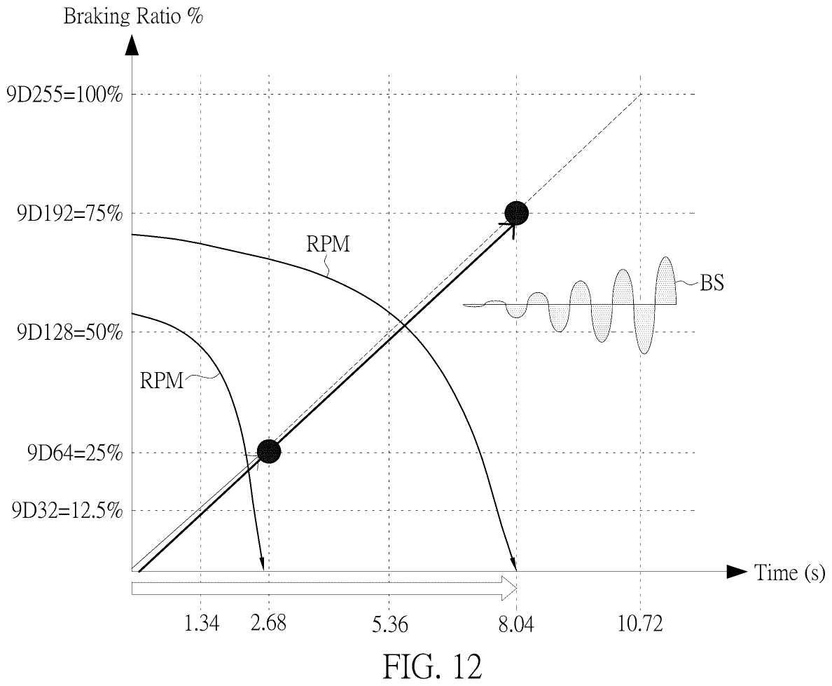

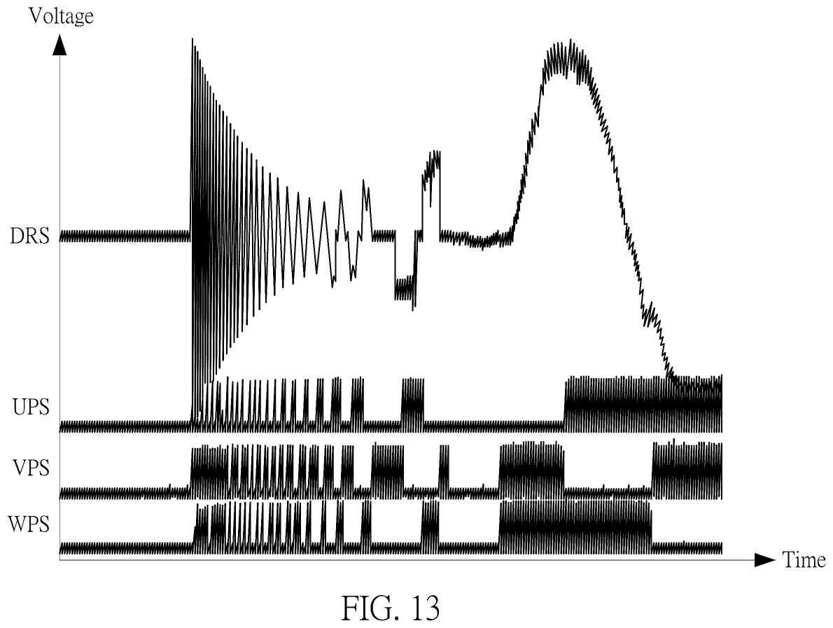

Reference is made to FIG. 10 to FIG. 13, in which FIG. 10 is a block diagram of a motor braking system using a multi-phase reversal mechanism according to an eighth embodiment of the present disclosure, FIG. 11 and FIG. 13 are waveform diagrams of signals of the motor braking system using the multi-phase reversal mechanism according to the eighth embodiment of the present disclosure, and FIG. 12 is a curve diagram of signals of the motor braking system using the multi-phase reversal mechanism according to the eighth embodiment of the present disclosure.

As shown in FIG. 10, in the eighth embodiment, the motor braking system of the present disclosure includes the motor voltage detecting circuit DET, the rotational speed determining circuit PRS, the rotor position detecting circuit HAL, the selector circuit SLE, the driver circuit DRV, the output stage circuit STG and the waveform pattern generating circuit WRA. The selector circuit SLE is connected to the rotational speed determining circuit PRS, the rotor position detecting circuit HAL and the driver circuit DRV.

In the motor driving mode, the selector circuit SLE selects one of two signals that are the motor rotational speed indicating signal outputted by the rotational speed determining circuit PRS and the commutation signal outputted by the rotor position detecting circuit HAL, and outputs the one of two signals to the driver circuit DRV.

In the motor driving mode, the driver circuit DRV, according to the one of two signals that is selected by the selector circuit SLE, determines which one of the three phases of the three-phase motor MT is the phase from which the current flows and determines which one of the three phases of the three-phase motor MT is the phase to which the current flows.

In the motor driving mode, the driver circuit DRV uses the phase from which the current flows as the first driving phase, and selects another of the three phases of the three-phase motor MT as the second driving phase.

It is worth noting that, in the motor braking mode, the driver circuit DRV changes the driving signal and outputs the changed driving signal to the output stage circuit STG such that the braking current is generated.

For example, the driver circuit DRV may increase a braking current over time as shown in FIG. 11 for increasing a braking speed of the three-phase motor MT. The reverse current of the three-phase motor MT described herein may be the same as a back electromotive force current CUBEMF shown in FIG. 11, and a total current of the three-phase motor MT may be the same as an output current CUOT shown in FIG. 11. The output current CUOT includes the back electromotive force current CUBEMF and a current flowing from the common voltage VCC.

Alternatively, the driver circuit DRV may increase a braking ratio over time as shown in FIG. 12. The driver circuit DRV may increase an on-time of any one of the high-side switches (including the first high-side switch TH1, the second high-side switch TH2 and the second high-side switch TH2) for realizing the increase in the braking ratio over time. The larger the on-time of the one of the high-side switches is, the larger the braking current such as a reverse current BS shown in FIG. 12 is. The driver circuit DRV may brake the three-phase motor MT according to a plurality of braking ratios such as 100% corresponding to a code 9D255, 75% corresponding to a code 9D192, 50% corresponding to a code 9D128, 25% corresponding to a code 9D64, 12.5% corresponding to a code 9D32 as shown in FIG. 12 respectively within a plurality of time intervals.

For example, a voltage signal of the U-phase terminal of the three-phase motor MT (or the first node NODEU between the first terminal of the first low-side switch TL1 and the second terminal of the first high-side switch TH1) may be the same as a voltage signal UPS shown in FIG. 13, but the present disclosure is not limited thereto.

For example, a voltage signal of the V-phase terminal of the three-phase motor MT (or second node NODEV between the first terminal of the second low-side switch TL2 and the second terminal of the second high-side switch TH2) may be the same as a voltage signal VPS shown in FIG. 13, but the present disclosure is not limited thereto.

For example, a voltage signal of the W-phase terminal of the three-phase motor MT (or third node NODEW between the first terminal of the third low-side switch TL3 and the second terminal of the third high-side switch TH3) may be the same as a voltage signal WPS shown in FIG. 13, but the present disclosure is not limited thereto.

The driver circuit DRV, according to the voltage signal UPS, VPS, WPS, determines which one of the three phases of the three-phase motor MT is the phase from which the current flows and determines which one of the three phases of the three-phase motor MT is the phase to which the current flows.

The driver circuit DRV changes the driving signal and outputs the changed driving signal to the output stage circuit STG to generate a reverse resistance which causes reduction in the rotational speed of the three-phase motor MT for realizing braking the three-phase motor MT. The rotational speed of the three-phase motor MT may be the same as a rotational speed RPM being reduced over time as shown in FIG. 12. Amplitudes of voltages of earlier ones of a plurality of waveforms of an output voltage signal DRS of the three-phase motor MT are reduced over time as shown in FIG. 13.

In conclusion, the present disclosure provides the motor braking system using the multi-phase reversal mechanism. The motor braking system of the present disclosure precisely controls rotation of the three-phase motor of the device (such as the fan). In particular, the motor braking system of the present disclosure is capable of effectively reducing the rotational speed of the three-phase motor for braking the three-phase motor. When any one of the plurality of fans is removed from the accommodation space in the electronic device (such as the server) and the new fan is installed into the electronic device, the motor braking system of the present disclosure brakes the three-phase motor of the one of the plurality of fan, thereby preventing the fans in the electronic device from rotating abnormally along the reverse direction.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor braking system using a multi-phase reversal mechanism, which is applicable to a three-phase motor, the motor braking system comprising:
a motor voltage detecting circuit connected to the three-phase motor;
a driver circuit connected to the motor voltage detecting circuit and configured to output a driving signal; and
an output stage circuit connected to the driver circuit and the three-phase motor, and configured to drive the three-phase motor according to the driving signal;
wherein, in a motor driving mode, the motor voltage detecting circuit detects voltage signals of one or more of three phases of the three-phase motor to output a voltage detected signal;
wherein, in the motor driving mode, the driver circuit, according to the voltage detected signal, determines which one of the three phases of the three-phase motor is a phase from which a current flows as a first driving phase, and selects another of the three phases of the three-phase motor as a second driving phase;
wherein, in a motor braking mode, the driver circuit changes the driving signal such that a reverse current flows from the second driving phase to the first driving phase.

2. The motor braking system according to claim 1, further comprising:
a waveform pattern generating circuit connected to the driver circuit and configured to output a plurality of reference pattern waveform signals;
wherein the driver circuit drives the output stage circuit according to the plurality of reference pattern waveform signals.

3. The motor braking system according to claim 1, wherein the output stage circuit includes:
a plurality of high-side switches including:
a first high-side switch, wherein a first terminal of the first high-side switch is coupled to a first input supply voltage;
a second high-side switch, wherein a first terminal of the second high-side switch is coupled to a second input supply voltage; and
a third high-side switch, wherein a first terminal of the third high-side switch is coupled to a third input supply voltage; and
a plurality of low-side switches including:
a first low-side switch, wherein a first terminal of the first low-side switch is connected to a second terminal of the first high-side switch, a first node between the first terminal of the first low-side switch and the second terminal of the first high-side switch is connected to a first terminal of a first phase coil of the three-phase motor, and a second terminal of the first low-side switch is coupled to a first reference voltage level;
a second low-side switch, wherein a first terminal of the second low-side switch is connected to a second terminal of the second high-side switch, a second node between the first terminal of the second low-side switch and the second terminal of the second high-side switch is connected to a first terminal of a second phase coil of the three-phase motor, and a second terminal of the second low-side switch is coupled to a second reference voltage level;
a third low-side switch, wherein a first terminal of the third low-side switch is connected to a second terminal of the third high-side switch, a third node between the first terminal of the third low-side switch and the second terminal of the third high-side switch is connected to a first terminal of a third phase coil of the three-phase motor, and a second terminal of the third low-side switch is coupled to a third reference voltage level;
wherein a control terminal of each of the plurality of high-side switches and a control terminal of each of the plurality of low-side switches are connected to the driver circuit, and a second terminal of the first phase coil, a second terminal of the second phase coil and a second terminal of the third phase coil are connected to a common node.

4. The motor braking system according to claim 3, wherein, in the motor driving mode, the driver circuit turns on one of the plurality of high-side switches that is connected to the first driving phase, and turns on one of the plurality of low-side switches that is connected to the second driving phase.

5. The motor braking system according to claim 4, wherein, in the motor braking mode, the driver circuit turns on one of the plurality of high-side switches that is connected to the second driving phase, and turns on one of the plurality of low-side switches that is connected to the first driving phase.

6. The motor braking system according to claim 3, further comprising:
a comparator, wherein a first input terminal of the comparator is connected to an output terminal of the motor voltage detecting circuit, a second input terminal of the comparator is connected to the common node, and an output terminal of the comparator is connected to an input terminal of the driver circuit;
wherein the driver circuit, according to a comparing signal from the comparator, determines which one of the three phases of the three-phase motor is the phase from which the current flows and determines which one of the three phases of the three-phase motor is the phase to which the current flows.

7. The motor braking system according to claim 3, further comprising:
a comparator, wherein a first input terminal of the comparator is connected to an output terminal of the motor voltage detecting circuit, a second input terminal of the comparator is grounded or coupled to a common voltage, and an output terminal of the comparator is connected to an input terminal of the driver circuit;
wherein the driver circuit, according to a comparing signal from the comparator, determines which one of the three phases of the three-phase motor is the phase from which the current flows and determines which one of the three phases of the three-phase motor is the phase to which the current flows.

8. The motor braking system according to claim 1, further comprising:
a rotational speed determining circuit connected to the motor voltage detecting circuit and the driver circuit, and configured to determine a rotational speed of the three-phase motor to output a motor rotational speed indicating signal according to the voltage detected signal;
wherein the driver circuit drives the output stage circuit according to the motor rotational speed indicating signal.

9. The motor braking system according to claim 8, wherein the driver circuit determines which one of a plurality of waveform segments of the motor rotational speed indicating signal corresponds to one of a plurality of waveform segments of the voltage detected signal, and accordingly determines which one of the three phases of the three-phase motor is the phase from which the current flows and which one of the three phases of the three-phase motor is the phase to which the current flows within a time interval of each of the plurality of waveform segments of the motor rotational speed indicating signal.

10. The motor braking system according to claim 1, wherein the three phases of the three-phase motor includes a first phase, a second phase and a third phase, and the driver circuit divides each of a plurality of operation cycle periods of the three-phase motor into a plurality of time intervals;
wherein, within each of the plurality of time intervals, the driver circuit changes the driving signal such that the reverse current flows from the second driving phase to the first driving phase of the three-phase motor.

11. The motor braking system according to claim 10, wherein, within a first time interval among the plurality of time intervals, the current flows from the third phase to the second phase of the three-phase motor, and the driver circuit changes the driving signal such that the reverse current flows from the second phase to the third phase of the three-phase motor.

12. The motor braking system according to claim 11, wherein, within a second time interval among the plurality of time intervals, the current flows from the third phase to the first phase of the three-phase motor, and the driver circuit changes the driving signal such that the reverse current flows from the first phase to the third phase of the three-phase motor.

13. The motor braking system according to claim 12, wherein, within a third time interval among the plurality of time intervals, the current flows from the second phase to the first phase of the three-phase motor, and the driver circuit changes the driving signal such that the reverse current flows from the first phase to the second phase of the three-phase motor.

14. The motor braking system according to claim 13, wherein, within a fourth time interval among the plurality of time intervals, the current flows from the second phase of to the third phase of the three-phase motor, and the driver circuit changes the driving signal such that the reverse current flows from the third phase to the second phase of the three-phase motor.

15. The motor braking system according to claim 14, wherein, within a fifth time interval among the plurality of time intervals, the current flows from the first phase to the third phase of the three-phase motor, and the driver circuit changes the driving signal such that the reverse current flows from the third phase to the first phase of the three-phase motor.

16. The motor braking system according to claim 15, wherein, within a sixth time interval among the plurality of time intervals, the current flows from the first phase to the second phase of the three-phase motor, and the driver circuit changes the driving signal such that the reverse current flows from the second phase to the first phase of the three-phase motor.

17. A motor braking system using a multi-phase reversal mechanism, which is applicable to a three-phase motor, the motor braking system comprising:
a rotor position detecting circuit disposed on the three-phase motor;
a driver circuit connected to the rotor position detecting circuit and configured to output a driving signal; and
an output stage circuit connected to the driver circuit and the three-phase motor, and configured to drive the three-phase motor according to the driving signal;
wherein, in a motor driving mode, the rotor position detecting circuit detects a position of a rotor of the three-phase motor to output a commutation signal, and the driver circuit drives the output stage circuit according to the commutation signal;
wherein, in the motor driving mode, the driver circuit, according to the commutation signal, determines which one of three phases of the three-phase motor is a phase from which a current flows as a first driving phase, and selects another of the three phases of the three-phase motor as a second driving phase;
wherein, in a motor braking mode, the driver circuit changes the driving signal such that a reverse current flows from the second driving phase to the first driving phase.

18. The motor braking system according to claim 17, wherein the rotor position detecting circuit includes:
a Hall sensor connected to the driver circuit, and configured to sense a positive voltage and a negative voltage that are generated with a change in a magnetic field generated by the three-phase motor of which the rotor is rotating to output the commutation signal.

19. The motor braking system according to claim 17, further comprising:
a motor voltage detecting circuit connected to the three-phase motor;
wherein, in the motor driving mode, the motor voltage detecting circuit detects the voltage signals of one or more of the three phases of the three-phase motor to output a voltage detected signal, and the driver circuit outputs the driving signal according to the voltage detected signal.

20. The motor braking system according to claim 19, further comprising:
a rotational speed determining circuit connected to the motor voltage detecting circuit, and configured to determine a rotational speed of the three-phase motor to output a motor rotational speed indicating signal according to the voltage detected signal; and
a selector circuit connected to the rotor position detecting circuit, the rotor position detecting circuit and the driver circuit, and configured to select one of two signals that are the motor rotational speed indicating signal and the commutation signal;
wherein the driver circuit, according to the one of the two signals, determines which one of the three phases of the three-phase motor is the phase from which the current flows and which one of the three phases of the three-phase motor is the phase to which the current flows.
